(19) United States
(12) Patent Application Publication
(10) Pub. No.: US 2003/0017300 A1
(43) Pub. Date: Jan. 23, 2003

(54) Floor protector

(76) Inventor: John Clay, San Fracisco, CA (US)

Correspondence Address: MILORD & ASSOCIATES, 2029 CENTURY PARK EAST, SUITE 1700, LOS ANGELES, CA, 90067

(21) Appl. No.: 09/907,791

(22) Filed: Jul. 18, 2001

(51) Int. Cl. B32B 3/10

(52) U.S. Cl. 428/100; 428/99; 428/131; 428/136

(57) ABSTRACT

A floor protecting device made of a generally planar sheet having an axially defined opening therein such that an inner edge defines the opening. An outer edge distal to the inner edge defines an outer periphery of the sheet. A resealable slit extends from the inner edge to the outer edge and allows installation of the sheet around the base of a fixture.

### FIELD OF THE INVENTION

The invention relates to a floor protector in general, and more specifically relates to a protective floor mat for use on the base of a beauty or hair salon chair, such mat having an absorbent layer on the top and a bottom layer of plastic or other suitable material being impervious to liquid such that spilled liquid is maintained between the absorbent and plastic layers thereby protecting the floor from said chemicals.

### BACKGROUND OF THE INVENTION

Protective floor mats are known in the prior art and are widely used. For example, U.S. Pat. No. 3,445,083 to Moss discloses a thin floor mat with downward gripping edges for use upon and protection of soft flooring from an object placed on top of said mat, while U.S. Pat. No. D330,988 to Robbins, III discloses a protective floor mat for use specifically with a chair placed directly on it. Neither Moss nor Robbins allow for absorbing chemicals. Further, neither invention is disposable, nor can either be folded and stored easily. Finally, neither invention has a means to install or remove the mat around an affixed object through the use of a slit secured by hook and loop fasteners or any other suitable securing device.

U.S. Pat. No. 5,667,873 to Beckenbach discloses a means to improve resistance to horizontal movement of protective floor mats specifically on carpet through the use of conoidal protuberances on the undersides of mats. U.S. Pat. No. D411,703 to France discloses a mat specifically for use in the bathroom having concentric circles on the top surface and a multitude of suction cups on the underside. Neither Beckenbach nor France contemplates absorption of chemicals and both inventions are not manufactured in a cost efficient manner to allow disposal thereof. Neither Beckenbach nor France discloses a means to install or remove the mat around the base of an affixed article through the use of a securable slit. More specifically, France's invention is solely for use in a bathroom and Beckenbach's invention concerns the underside of the mat as it relates to use on carpet irrespective of the surface of the mat.

U.S. Pat. No. D402,841 to Dobbs discloses a securable rug to be used around the base of a toilet in a bathroom. The rug has a horseshoe shape and a strap attached to one inner back edge that is to be wrapped around the back of the toilet and attached to the other inner back edge with a fastening device, thereby securing the rug and preventing shifting and slipping of said rug. Dobbs's invention is not disposable or suitable for use in a hair salon in a practical or efficient manner as it is topped with heavy carpet and has an underside without a liquid-proof lining necessary to prevent chemicals from leaking though and damaging the floor. In addition, Dobbs fails to provide a floor protector that is capable of covering a 360° radius around the base of the fixture. Furthermore, Dobbs's invention is not lightweight or easily foldable for storage or disposable.

Some of the aforementioned floor mats are designed to protect floors in high traffic areas from excessive wear. Others are specifically designed for use in the bathroom. Most do not have an absorbent quality, none are disposable, none are easily foldable for storage, and most do not have the ability to be installed around the base of a fixture, and therefore none are suitably designed for easy, effective protection of a salon floor from chemical damage. Therefore, there remains a continuing need for an advance in the art beyond the existing floor protecting mats that is absorbent, fast drying, foldable, reusable and disposable, and is easy to install, secure, and remove.

### SUMMARY OF THE INVENTION

The invention relates to an absorbent, fast-drying, reusable, disposable protective floor mat for use around the base of beauty salon chairs to prevent damage to the floor from spilled chemicals used in coloring and processing hair.

The mat is of sufficient size to protect the working area around the base of a salon chair. The opening is substantially centrally located and is of sufficient size to accommodate the base of the salon chair. The mat is comprised of an absorbent top layer and a liquid-proof bottom layer which is unaffected by the chemicals contained in hair coloring and processing products. The mat has a slit that completely transects the wall of the mat, spanning the edge of the inner opening to the outer edge of the mat, creating an opening which allows the mat to be easily installed around the base of an affixed salon chair. The slit is lined on each edge with a securing means, such as hook and loop fasteners or any other suitable securing device, enabling the mat to be secured around the base of the salon chair.

The absorbent top layer may be comprised of a plurality of layers of suitable absorbent, lightweight and fast drying material quilted together. The bottom layer is comprised of a thin, lightweight plastic or other suitable material that is impervious to liquid and unaffected by the chemicals found in hair coloring and processing products.

The top and bottom layers are firmly attached together in a planar fashion, by sewing or any other suitable means, around the edge of the inner opening, around the outer edge of the mat, and along both edges of the slit. The edges of the slit are lined from inner opening to outer edge with a securing means, such as hook and loop fasteners or any other suitable securing device, allowing the mat to be secured easily and firmly around the base of a salon chair, as well as removed easily from said chair.

Therefore, it is a primary objective of the invention to provide a protective floor mat that overcomes the disadvantages of the prior art.

It is another objective of the invention to provide an efficient means to protect salon floors from damage caused by chemicals spilled during hair coloring and processing.

It is another objective of the invention to provide a protective floor mat that is absorbent.

It is another objective of the invention to provide a protective floor mat that has a liquid-proof bottom layer which is unaffected by the chemicals found in hair coloring and processing products, which prevents said chemicals from reaching the floor.

It is yet another objective of the invention to provide a fast drying protective floor mat for quicker storage and reuse.

It is a further objective of the invention to provide a protective floor mat that is reusable.

It is another objective of the invention to provide a protective mat that is disposable at the discretion of the user.

It is another objective of the invention to provide a protective floor mat that is simple to install and to remove.

It is yet another objective of the invention to provide a protective floor mat that is easy to firmly secure with hook and loop fasteners or any other suitable securing device.

It is a further objective of the invention to provide a protective floor mat that is easy to fold and store.

It is another objective of the invention to provide a protective floor mat that is cost efficient and stylish.

It is another objective of the invention to provide a protective floor mat that prevents injury due to slipping caused by chemicals spilled on the floor.

It is yet another objective of the invention to prevent floor damage away from the working area of the salon chair due to tracking spilled chemicals on shoes.

Such stated objectives and advantages of the invention are only examples and should not be construed as limiting this invention. Other objectives and advantages of the invention herein will become more apparent from the detailed description of the invention and the claims that follow.

### BRIEF DESCRIPTION OF THE DRAWINGS

FIG. 1 is a top plan view of a preferred embodiment of a floor protector.

FIG. 2 is a bottom view of a floor protector.

FIG. 3 is a perspective view of a floor protector with a slit in an unsecured position.

FIG. 4 is a perspective view of a floor protector illustrating the slit in a secured position.

FIG. 5 is a perspective view of a preferred embodiment of a floor protector illustrating a plurality of layers comprising the top layer.

### DETAILED DESCRIPTION OF THE INVENTION

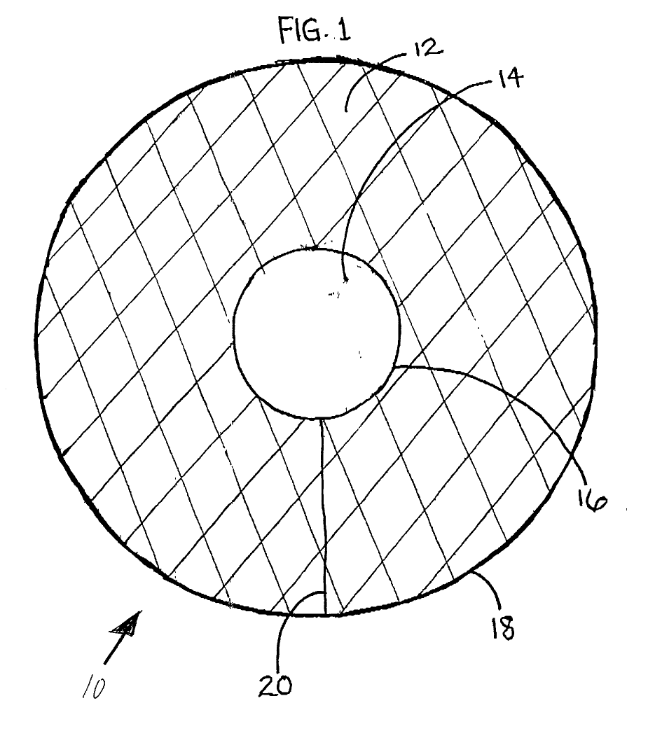

Referring now to FIG. 1, a sheet 10 is preferably planar in nature. For the purpose of illustration but not limitation, in one preferred embodiment sheet 10 has a generally annular shape; however, it is to be understood that sheet 10 may also be made of a plurality of polygonal shapes. Sheet 10 is of sufficient size to cover the working area around the base of a beauty salon chair. Sheet 10 may also be made of a plurality of layers. A top layer 12 preferably has absorbent characteristics. Top layer 12 can be comprised of any suitable absorbent, thin, fast drying and lightweight material such as fabric. An opening 14 that is substantially centrally located extends axially through sheet 10 such that an inner edge 16 defines opening 14. Opening 14 can be of any size sufficient to accommodate the base of a salon chair. An outer edge 18 defines a periphery of sheet 10. A slit 20 extends from inner edge 16 to outer edge 18 of sheet 10.

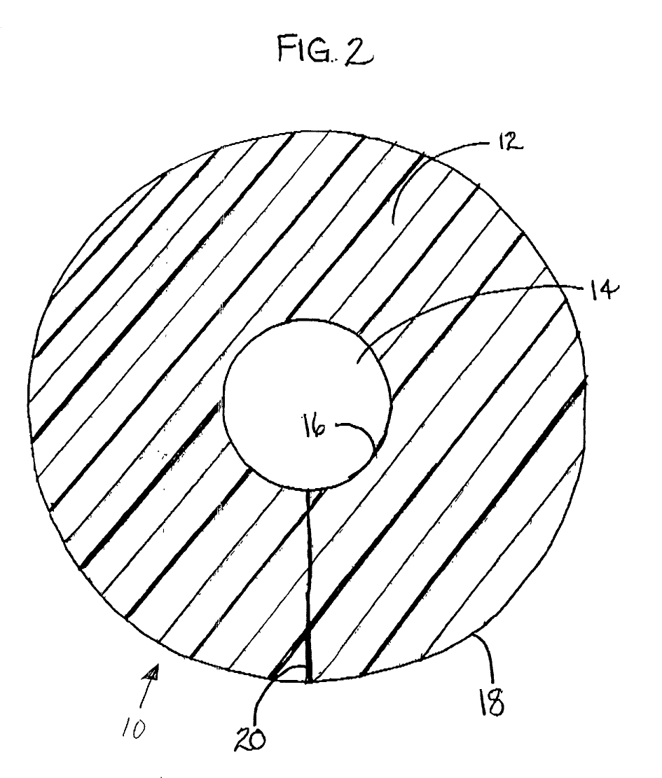

Referring now to FIG. 2 and FIG. 3, a bottom layer 22 of sheet 10 is comprised of thin, lightweight, flexible material such as, but not limited to, plastic or any other suitable material impervious to liquid and unaffected by chemicals contained in hair coloring and processing products. Bottom layer 22 is connected to top layer 12 by sewing or any other suitable attaching means along inner edge 16, outer edge 18, a first edge 24 and second edge 26 that defined slit 20.

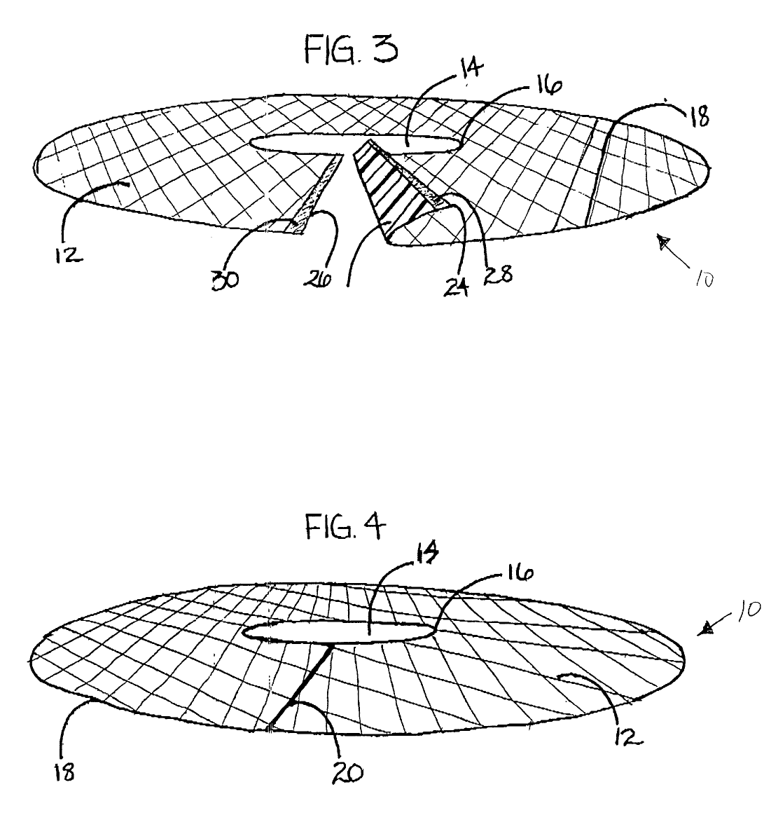

Referring specifically now to FIG. 3, slit 20 is illustrated in an unsecured position with first edge 24 turned back to reveal a securing means 28, such as hook and loop fasteners or other suitable securing device, attached by any suitable means to bottom layer 22 of first edge 24 of slit 20, while a compatible securing means 30 is attached to top layer 12 of a second edge 26 of slit 20. In the unsecured position, sheet 10 is slid in a horizontal position such that a fixture (not shown) would pass through slit 20 and be received within opening 14. Referring now to FIG. 4, sheet 10 is illustrated in a secured position and would thus enclose the fixture (not shown) within opening 14 by engaging securing means 28 to securing means 30. The fixture, for purposes of illustration but not limitation, is preferably a beauty salon chair.

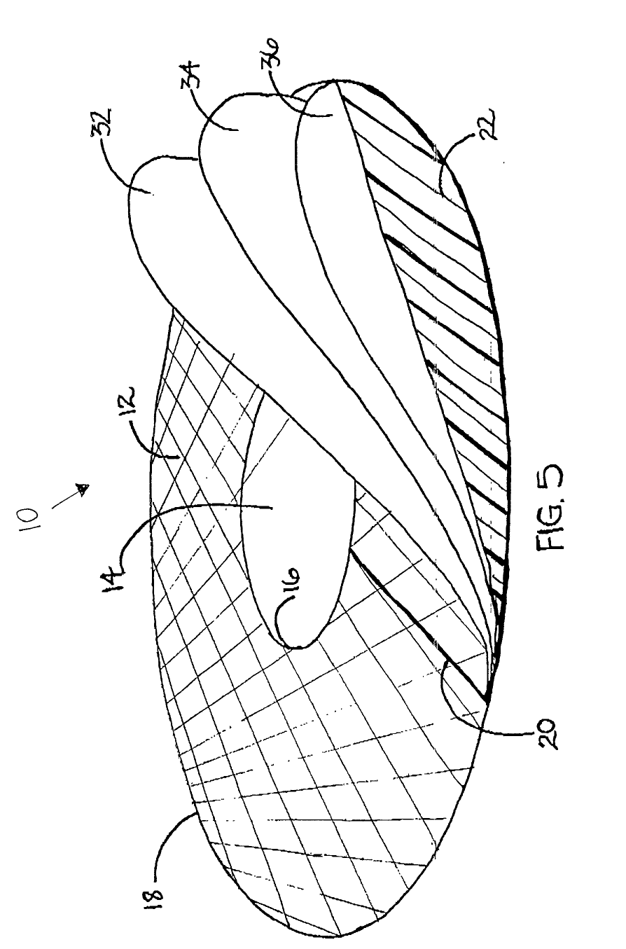

Referring now to FIG. 5, for purposes of illustration and not limitation, top layer 12 may be made of a plurality of absorbent layers. In one preferred embodiment, top layer 12 is made of a first layer 32, a second layer 34 and a third layer 36. Layers 32, 34, and 36 are assembled and attached by any suitable means to bottom layer 22 along inner edge 16, outer edge 18, and along edges 24 and 26 of slit 20. The layers of material may use moisture locking technology that is known in the art, and commonly used with diapers and feminine hygiene products, to trap spilled liquids therein and to prevent transferring of the liquid onto the shoes of an individual that steps onto sheet 10.

While the above description contains many specifics, these should not be construed as limitations on the scope of the invention, but rather as an exemplification of preferred embodiments thereof. Many other variations are possible without departing from the essential spirit of this invention. Accordingly, the scope of the invention should be determined not by the embodiment illustrated above, but rather by the appended claims and their legal equivalents.

What is claimed is:

1. A floor protecting device, comprising:
a generally planar sheet;
an opening defined axially through said sheet whereby an inner edge is formed;
an outer edge distal to said inner edge defining the boundary of said sheet; and
a resealable slit extending from said inner edge to said outer edge and being defined by a first edge and a second edge.

2. The device of claim 1, wherein a securing means is located on said first edge and said second edge.

3. The device of claim 2, wherein said securing means is a hook and loop fastener.

4. The device of claim 1, wherein the sheet consists of a top layer and a bottom layer.

5. The device of claim 4, wherein said top layer consists of an absorbent material.

6. The device of claim 4, wherein said bottom layer consists a material that is impermeable to a fluid.

7. The device of claim 4, wherein said bottom layer is made of plastic.

8. The device of claim 4, wherein said top layer is comprised of a first layer, a second layer, and a third layer, each of the first, second, and third layers having absorbent characteristics.

9. The device of claim 8, wherein the first, second, and third layers have fluid retaining qualities that prevents transferring of fluid maintained therein.

10. The device of claim 4, wherein the bottom layer is constructed of a material that prevents sliding thereof.

11. The device of claim 1, wherein said opening is of sufficient size to accommodate a base of a beauty salon chair and said outer edge is of sufficient length to capture any spilled fluids.

12. A protective floor mat device, comprising:
a generally planar sheet;
a top layer and a bottom layer defining said planar sheet;
an opening extending substantially axially through said top layer and said bottom layer and said opening being defined by an inner edge;
an outer edge distal to said inner edge defines a periphery of said sheet;
a resealable slit extending from the inner edge to the outer edge, and said slit being defined by a first edge and a second edge.

13. The device of claim 12, wherein said top layer consists of an absorbent material.

14. The device of claim 12, wherein said top layer consists of a first layer, a second layer, and a third layer that consist of an absorbent material.

15. The device of claim 14, wherein said first layer, second layer, and third layer have fluid locking properties to prevent transfer of fluids maintained therein.

16. The device of claim 12, wherein said bottom layer is impermeable to fluid.

17. The device of claim 12, wherein a releasable fastening means is maintained on said first edge and said second edge.

18. The device of claim 12, wherein said opening is of sufficient size to accommodate a base of a beauty salon chair and said outer edge is of sufficient radius to capture fluid spilled thereon.

19. In combination, a floor protecting device for use around a base of a beauty salon chair for capturing spilled fluid, comprising:
a generally planar sheet having a top layer and a bottom layer;
an opening axially defined through said top layer and said bottom layer such that an inner edge defines said opening, and said opening being of sufficient size to accommodate the base of the beauty salon chair;
an outer edge distal to said inner edge and of sufficient size to capture any spilled fluid;
a slit extending from said inner edge to said outer edge to accommodate the base of the chair during installation of the sheet, said slit being defined by a first edge and a second edge; and
a releasable attaching means attached to said first edge and said second edge.

20. The device of claim 19, wherein said top layer is comprised of a first layer, a second layer, and a third layer, each of the first, second, and third layers having absorbent characteristics and also having a fluid locking nature to prevent transferring of fluid maintained therein.
